(19) United States
(12) Patent Application Publication
(10) Pub. No.: US 2021/0177127 A1
(43) Pub. Date: Jun. 17, 2021

(54) Water enrichment Bottle

(71) Applicant: Yaakov Dahan, Rishon LeTsiyon (IL)

(72) Inventor: Yaakov Dahan, Rishon LeTsiyon (IL)

(21) Appl. No.: 16/718,175

(22) Filed: Dec. 17, 2019

(51) Int. Cl. A45F 3/18; C02F 1/68

(52) U.S. Cl. CPC A45F 3/18; C02F 1/687

(57) ABSTRACT

A portable water enrichment water bottle is characterized by comprising a bottle top cap, a bottle body, a bottle bottom circular area and a water-permeation porous sealed stainless-steel container fixedly arranged between the bottle bottom cap and the bottle body. An active material is arranged inside the water-permeation porous sealed stainless-steel container. The active material is usually in shape of a pebble which can be of including but not limited to mineral, food or dietary supplement, baking soda, pure silver, gemstones, crystals and other similar articles. Once the active material contacts with water, positive potential value can be generated. Only by filling the water-permeation porous sealed stainless-steel container with pebble of the active material and without using an electrolyze, water can be simply converted to highly charged, active, clean and neutralized water which is simple to use and is convenient to operate.

### COPYRIGHT NOTICE

A portion of the disclosure of this patent document contains material which is subject to copyright protection. The copyright owner has no objection to the facsimile reproduction by anyone of the patent disclosure, as it appears in the Patent and Trademark Office parent flies or records, but otherwise reserves all copyright rights whatsoever.

### BACKGROUND

### Field of the Invention

The present invention relates to drinking water compositions and enhancement and in particular relates to improves drinking water taste, energize and addition variety of nutritional supplements.

### Description of the Related Art

In many countries, typically do not contain sufficient amounts of dietary iron, zinc, iodine, vitamin A or vitamin B. Has been amply studied iron deficiency problem. Despite the lack of a nutritional deficiency are just a few in the United States, but it is more common in most developing countries. Recent evidence suggests that nutritional zinc deficiency may be more common in many populations in developing countries, the people in these areas rely on plant-derived foods (such as cereals and legumes) life. Because of self-imposed dietary restrictions, consumption of alcohol and cereal proteins, and fine food to reduce the increasing intake of trace minerals, marginal zinc deficiency may be widespread even in the United States.

Similarly, a lot of the research on structured water has come together in the last decade or so employing that Structured water, also known as hexagonal water exclusion zone (EZ) water, has many biological roles that are important to life. There are two methods of using structured water to support one's health. One is to create structured water from the water already in your body. The other way is to create structured water for drinking.

There are multiple inventions that have been proposed in prior art regarding providing advancements for consumers. For instance, a bottled oxygen enrichment bodybuilding water bearing Chinese patent 2,028,97216U is issued. to Chinese inventor. The utility model relates to skin care products, in particular to bottled oxygen enrichment bodybuilding water. The bottled oxygen enrichment bodybuilding water comprises a bottle body and a bottle cover, wherein the bottle body is a bodybuilding water bottle, the bottle cover seals the bottle body, and the bottle body is filled with oxygen enrichment water. The bottled oxygen enrichment bodybuilding water has the advantages of being small in size and convenient to store, transport and use. The bottled oxygen enrichment bodybuilding water meets the needs of daily moisturizing and bodybuilding.

Another patent on Oxygen-enriched water bottled drink bearing Chinese patent 2,030,64520U is issued to Chinese inventor. The utility model relates to drinks, in particular to an oxygen-enriched water bottled drink. According to the oxygen-enriched water bottled drink, a bottle body and a bottle cover are included. The bottle body is a drink bottle. The bottle cover seals the bottle body, and oxygen-enriched water is filled in the bottle body, The oxygen-enriched water bottled drink has the advantages of being small in size, and convenient to store, transport and use. Daily drinking needs of people can be met. The O3 is dissolved in the oxygen-enriched water, and the water needs to achieve a level of drinking water. After people drink the oxygen-enriched water, oxygen content inside a human body can be rapidly replenished. The oxygen-enriched water bottled drink has the functions of killing bacteria, diminishing inflammation, supplying blood oxygen, promoting microcirculation and the like.

Another patent on kind of enrichment method of Organic Pollutants of Drinking Water bearing Chinese patent is issued to Chinese inventor. The invention belongs to Environmental Health and water analysis technical field, it is related to water analysis pre-treating method, and in particular to a kind of enrichment method of Organic Pollutants of Drinking Water. This method is by three kinds of sorbing materials such as integrated XAD 2, PSDVB and coconut husk class activated carbon, and fine-tune water sample pH value, realize that trace organic pollutant in water is drunk in wide spectrum enrichment, the enriched substance for being obtained can be not only used for drinking trace organic pollutant in water analysis of spectrum, be also applied for biological effect research. The present invention compensate for the single deficiency of enriched fractions species in existing method, while water sample enriching apparatus used are simple, sorbing material is easy to get and can reuse, organic pollution huge number can be enriched with, bioaccumulation efficiency is high, and enrichment capacity is big, and the inventive method is with a wide range of applications.

Another patent on Personal drinking water purification tube bearing U.S. Pat. No. 5,045,195A is issued to ACCUVENTURE Inc A DE CORP Accuventure Inc. The patent is on a portable personal water filtration and purification device which includes an elongate tubular filter housing with layers of mechanical filtration and contains a layer of granular activated charcoal impregnated with silver located between the layers of mechanical filter medium. A mouthpiece limits the rate of flow of water through the filter unit, while making it convenient to draw water through the filter. In one embodiment, a filter unit is attached to a flexible drinking tube and the filter unit is located within a portable water container conveniently carried by a person.

A Cone system and structure thereof to produce super-oxygenated and structured water bearing U.S. Pat. No. 7,243,910B2 is issued to David Bagley. The patent discusses a cone system to produce super-oxygenated and structured water is provided. The cone system includes a source of oxygen, and a plurality of cones in communication with the source of oxygen and configured to receive preconditioned water and spin the preconditioned water to combine it with oxygen received from the source. The system may be used with a system and method for producing and tuning super-oxygenated and structured water.

Another patent on Fortified drinking water bearing Chinese patent 1,003,66188C is issued to Chinese inventor. The patent discusses drinking water comprised of iron and zinc with minerals and/or vitamin fortified drinking water compositions having a clarity, color and improved flavor. The drinking water comprising at least 5 ppm of iron compound bioavailable, the oxidation resistant iron compound in the drinking water compositions, with or without an excess of reducing agent is fruit and/or vegetable flavoring and coloring agents to mask iron or metallic taste aftertaste. Vitamins such as vitamin B family, vitamin A, vitamin C, and vitamin E may optionally be added to the drinking water. The present invention discloses a method for the drinking strengthening certain bioavailable zinc and iron compounds without producing unpleasant transparency, color variation or metallic taste or aftertaste methods.

Another patent on System for adding consumable enhancing additives to drinking water bearing US patent 2,004,0055948A1 is issued to Egg Factory LLC. The embodiments of the present invention relate to a system for treating drinking water to enhance it with consumable additives such as vitamins and flavor. The system may be connectable to a source of drinking water such as home faucet, and operable to selectably introduce additives into the drinking water.

Another patent on Fiber nutritional drink bearing US patent 2,005,0013902A1 is issued to TNT Holdings LLC. The patent discusses a drink containing fiber and vitamins.

There are multiple patents that have been found in prior art regarding utilization of multiple methods to enhance the quality of drinking water. However, the technology and ease to consumer hasn't been effectively utilized keeping in view the rapid advancements in similar field. Moreover, the art in similar field is presented for use of single time only. Furthermore the inconvenience and cost of obtaining enhanced bottled water products on a regular basis, however, may discourage consumers from pursuing this potential source of better nutrition.

Accordingly, a more convenient and cost-effective approach for providing better nutrition to the public is called for. The current invention proposes a combination of technology which improves the taste of water and enhances the structure of water. It further provides the system to energizes the water. The current method proposes easy to consume vitamins, medicines, dietary and nutritional supplement by its unique methodology of adding nutritional pebbles in the water for consistent and long-term water intake.

None of the previous inventions and patents, taken either singly or in combination, is seen to describe the instant invention as claimed. Hence, the inventor of the present invention proposes to resolve and surmount existent technical difficulties to eliminate the aforementioned shortcomings of prior art.

### SUMMARY

In light of the disadvantages of the prior art, the following summary is provided to facilitate an understanding of some of the innovative features unique to the present invention and is not intended to be a full description. A full appreciation of the various aspects of the invention can be gained by taking the entire specification, claims, drawings, and abstract as a whole.

The primary desirable object of the present invention is to provide a novel and improved form of daily consumable water.

The main objective of the invention is to provide an improved bottled water for daily use which is structured and energized as per daily consumption health guidelines.

It is further the objective of the invention to provide energized water by using the technology of crystals infused in water bottle, where the water is structured water and acts as a healing tool.

The present invention also aims to provide an oxygen-rich bottled water to drink in order to fleet daily requirements.

A second objective of the present invention is to provide a mineral fortified drinking water composition.

It is further the objective of the invention to provide multiple spheres which have inbuilt dietary and other nutritional supplements and with different tastes that melts slowly in the water to provide nutrients as per health guidelines.

It is also the objective of the invention to provide a unique inventive method, where not only enriching apparatus are simple, but is also adaptable to get reused multiple times.

It is further the objective of the invention to provide sustainability and. environment protection by reducing the plastic bottle consumption.

It is also the objective of the invention to provide ease of use and convenience to the user and is available in attractive packaging.

Thus, it is the objective to provide a new and improved technology of water enrichment. Other aspects, advantages and novel features of the present invention will become apparent from the detailed description of the invention when considered in conjunction with the accompanying drawings.

This Summary is provided merely for purposes of summarizing some example embodiments, so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF DRAWINGS

FIG. 1 shows the top view of the assembly as per illustrative embodiments of the invention.

FIG. 2 shows the tilted view of the assembly also disclosing the bottom of bottle as per illustrative embodiments of the invention.

FIG. 3 shows the complete front view of the assembly as per illustrative embodiments of the invention.

FIG. 4 shows the complete back view of the assembly as per illustrative embodiments of the invention.

FIG. 5 shows the top and tilted front view of the assembly as per illustrative embodiments of the invention.

FIG. 6 shows the basal view of the assembly as per illustrative embodiments of the invention.

FIG. 7 shows the bottom upward view of the assembly as per illustrative embodiments of the invention.

FIG. 8 shows the cross-sectional view of the assembly also disclosing the internal tube with spheres as per illustrative embodiments of the invention.

FIG. 9 shows the cross-sectional inverted view of the assembly as per illustrative embodiments of the invention.

FIG. 10 shows the front cross-sectional view of the assembly as per illustrative embodiments of the invention.

### DETAILED DESCRIPTION

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

The present invention is directed to a system for structured and energized water with required nutrients for daily consumption.

In one embodiment, the prior studies have shown that many people are not receiving 100% of their RDA (recommended daily allowance) of vitamins and nutrients. A shortage of nutrients and vitamins in the diet may lead to health problems.

One way in which the marketplace has attempted to meet the need for better nutrition is through “enhanced” bottled water. Typically given such “fitness water” and “vitamin water,” enhanced bottled water products may be enhanced by the addition of common vitamins, minerals and nutrients; flavors may also be added to increase appeal to consumers. However, the current invention provides a further advancement in similar type of drinkable water.

As per preferred embodiments, the present methodology works on improving the taste of water by proposing unique flavored balls or spheres with different tastes that melts slowly in the water. This allows to create structured water due to the unique properties of sphere balls/pebbles enclosed within water in the bottle. It has been known that almost any form of energy exposed to water provides structured water. The Gemstones water bottle will not only provide structured water but will also enhance the nutritional supplements and flavor of the natural and pure water. It has been also known that structured water is a battery that needs constant charging. Energized structured water recharges the liquid battery of the body. When the body has sufficient energy, its aqueous interior is highly charged allowing for optimized cellular and metabolic function in addition to greater hydration and detoxification. The current method of structured and energized water allows for constant supply of energy to body of consumers and make them active and provide more absorption of energy, optimizing hydration and flushing out toxins from the body.

Another aspect of the present invention provides a crystal infused water bottle, combined with structure water which is unique embodiment of the current invention and will be used first time as a healing tool. Crystals integrates healing energy into our bodies. The crystal structure water bottle operates at the molecular and vibration level. They transfer the properties of crystals into the water and resultingly making it energy-charged enhances the effect on the metabolism and overall health of the consumer. The Crystal water bottles improve spiritual well-being, generates positive state of mind and meaningful living. It has a positive effect on our physical health as well and fosters tranquility, supports healthy and radiant skin.

As per additional embodiments of the invention the pebbles or stones bounded with easy to Consume vitamins, medicines, dietary and nutritional supplement. Generally, vitamin, multi-vitamin, and/or mineral preparations are commonly administered to inhibit, to prevent, or to reduce the frequency or severity of specific medical disorders. In particular, iron-containing preparations are used to alleviate disorders related to iron deficiency (e.g. anemia). Such preparations are also used as nutritional supplements. However, the current invention as compared to prior art provides a unique way of pebbles or stones which are added in water and they get dissolved slowly to provide required intake of nutrients and supplements. These pebbles or stones are moreover provided with flavors to enhance the structure and taste of water.

As per further embodiments of the invention the increase the alkalinity of water is also achieved by adding baking soda balls. The alkalinity of water is a measure of its ability to neutralize acids. As per widely believed phenomenon water alkalinity, or lack thereof, can have a profound effect on individual's health. Regardless of pH, it is recommended that any drinkable water be as free from toxins as possible. Dinking toxin free water is another way to keep body healthy. This can also be achieved by adding baking soda balls in water. These balls will slowly neutralize the acids and will make a healthy and glowing body.

As per further embodiments of the invention all of the additional supplement's effects multiply with magnetic properties which are working across the bottle. It has been widely accepted that passing water through a magnetic field has been claimed to improve chemical, physical and bacteriological quality of water in many different applications. This can be further achieved by magnets which are present within the body of bottle and will transfer positive energy to water and enhance its physical and chemical properties for the consumer.

As per further additional embodiments of the invention the assembly provides a reusable bottle which removes the negative usage effects of plastic or other type of reusable bottles. Typically, the reusable water bottles, have several drawbacks. These including rapidly warming and stale water, health issues related to long term use of the same plastic bottle, plastic odor, inconvenience of having to constantly carry the bottle and filling it from questionable tap waters, hygiene issues such as bacterial collection in nozzle and bottle interior, and finally, known harmful and potentially deadly agents such as BPA Bisphenol (BPA) found in inner coating of bottles. The current invention provides a reduced consumption of light drinks plastic disposable bottles and cans and further allows to consume nutritional flavored balls or pebbles combined with proposed unique functional bottle to reduce plastic pollution.

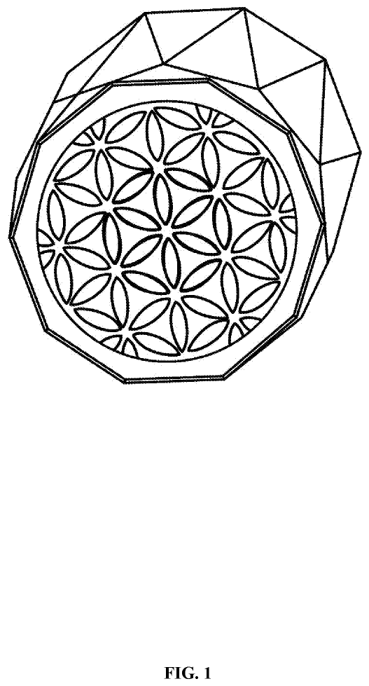

To explain the invention further, multiple views of water enrichment bottle are added. FIG. 1 shows the top view of the assembly as per illustrative embodiments of the invention. The assembly has a top design (1) with a plastic cover (2). The assembly has a cylindrical plastic or glass bottle (3) with hexagonal lines (4) across the body.

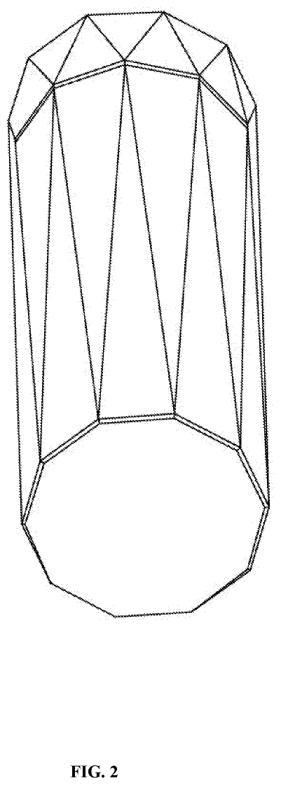

The FIG. 2 shows the tilted view of the assembly also disclosing the bottom of bottle as per illustrative embodiments of the invention. The assembly has a top design (1) with a plastic cover (2). The assembly has a cylindrical plastic or glass bottle (3) with hexagonal lines (4) across the body. The base of bottle (5) is circular and plain allowing stability of bottle.

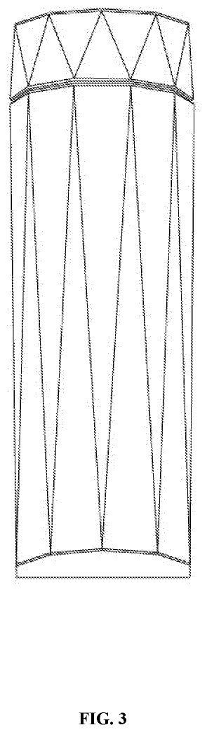

FIG. 3 shows the complete front view of the assembly as per illustrative embodiments of the invention. The assembly has a cover (2) which can be of plastic or glass as required. The assembly has a cylindrical plastic or glass bottle (3) with hexagonal lines (4) across the body. The base of bottle (5) is circular and plain allowing stability of bottle.

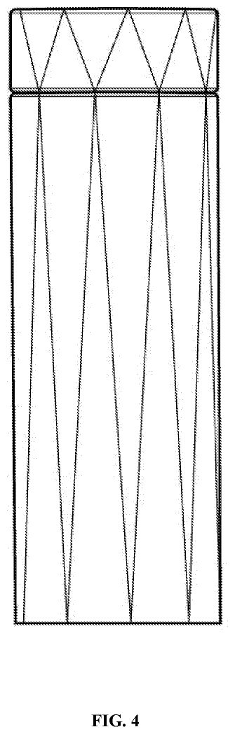

The FIG. 4 shows the complete back view of the assembly as per illustrative embodiments of the invention. The assembly has a cover (2) which can be of plastic or glass as required. The assembly has a cylindrical plastic or glass bottle (3) with hexagonal lines (4) across the body. The base is circular and plain allowing stability of bottle.

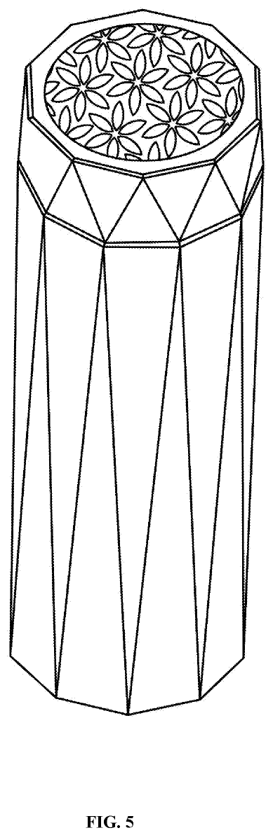

FIG. 5 shows the top and tilted front view of the assembly as per illustrative embodiments of the invention. The assembly has a top design (1) with a plastic cover (2). The design at the top of cover may vary as per bottle design. The assembly has a cylindrical plastic or glass bottle (3) with hexagonal lines (4) across the body.

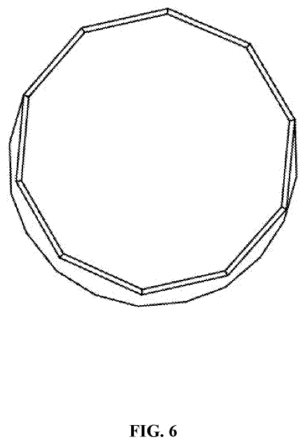

The FIG. 6 shows the basal view of the assembly as per illustrative embodiments of the invention. Where the base (5) is circular and plain allowing stability and support to bottle assembly.

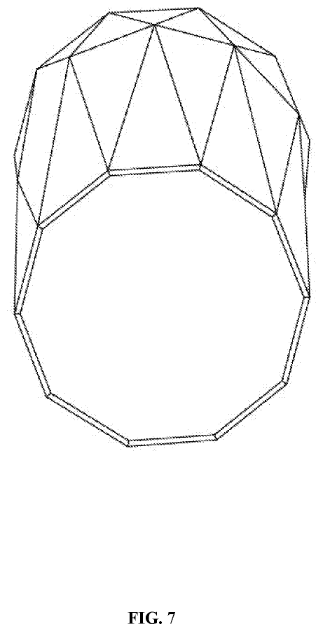

FIG. 7 shows the bottom upward view of the assembly as per illustrative embodiments of the invention. The base (8) can be seen which is circular and plain leading to straight body (3) with hexagonal lines (4) across the body of bottle assembly.

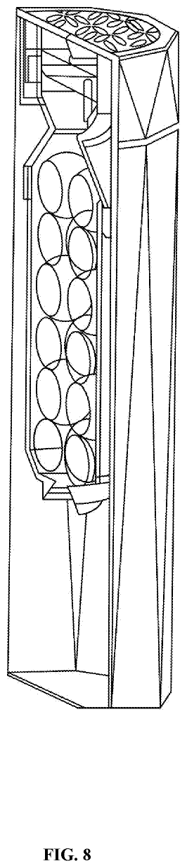

The FIG. 8 shows the cross-sectional view of the assembly also disclosing the internal tube with spheres as per illustrative embodiments of the invention. The inner view shows the cross-sectional view of inner cylindrical tube (6) which can be of common plastic or glass with inbuilt magnets. The assembly has a cork shaped cover (8) which secures the inner components securely. The inner components are stones (7) which can be made of including but not limited to dietary supplement, nutritional supplement, Vitamins, Medicines, Fruit flavors, Gem stones, glass, Beads, Magnets etc.

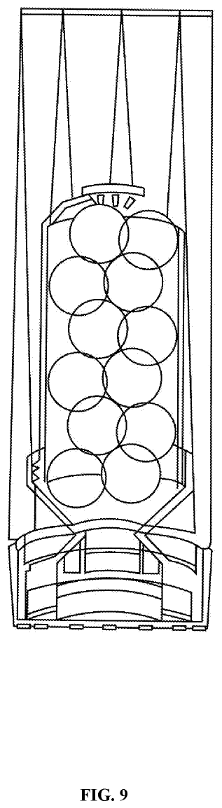

FIG. 9 shows the cross-sectional inverted view of the assembly as per illustrative embodiments of the invention. The inverted view showing the base (5) and the cross-sectional view of inner cylindrical tube (6) which can be of common plastic or glass with inbuilt magnets. The assembly has a cork shaped cover (8) which secures the inner components securely. The inner components are stones (7) which can be made of including but not limited to dietary supplement, nutritional supplement, Vitamins, Medicines, Fruit flavors, Gem stones, glass, Beads, Magnets etc.

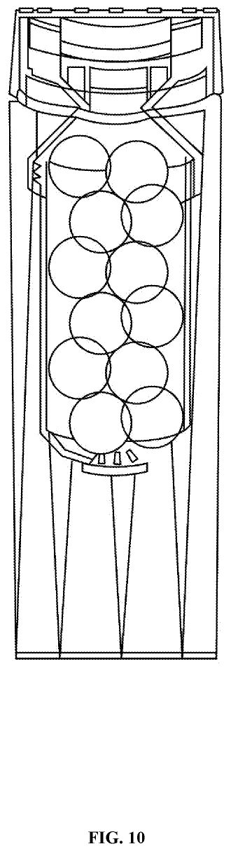

The FIG. 10 shows the front cross-sectional view of the assembly as per illustrative embodiments of the invention. The inner view shows the cross-sectional view of inner cylindrical tube (6) which can be of common plastic or glass with inbuilt magnets. The assembly has a cork shaped cover (8) which secures the inner components securely. The inner components are stones (7) which can be made of including but not limited to dietary supplement, nutritional supplement, Vitamins, Medicines, Fruit flavors, Gem stones, glass, Beads, Magnets etc.

While a specific embodiment has been shown and described, many variations are possible. With time, additional features may be employed. The particular shape or configuration of the platform or the interior configuration may be changed to suit the system or equipment with which it is used.

Having described the invention in detail, those skilled in the art will appreciate that modifications may be made to the invention without departing from its spirit. Therefore, it is not intended that the scope of the invention be limited to the specific embodiment illustrated and described. Rather, it is intended that the scope of this invention be determined by the appended claims and their equivalents.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

I: A water enrichment bottle consisting of:
common plastic and Glass periphery for bottle main assembly;
plastic or glass cap with grooved linings on the top;
an inner cylindrical periphery made of plastic or glass to receive the mineral stones;
a cork shaped cap for covering and sealing the inner cylindrical periphery however the cap has inlet secured for receiving the mineral stones;
mesh filters;
food grade silicon layers;
magnets;
minerals balls to produce mineral water;
vitamin halls to produce vitamin water;
fruit extracts balls to add fruit benefits in water;
herbs extract balls to add herbs benefits in water;
baking soda extracts in ball to reduce alkalinity of water;
Earthenware or pure silver balls to produce silver water; and
gem stones and crystals with food balls for necessary food supplements intake.

II: A water enrichment bottle and associated apparatus based on:
a generally parallelepipedal container body having generally parallel top and bottom portions and two sets of opposed sidewalls contiguous with and connecting said top and bottom portions to define an interior volume, said container body having rounded edges and corners;
said top portion having a central depression therein with a round hole surrounded by a cylindrical collar means for receiving a cap means for sealing said round hole;
said top portion having a cap with the grooved lining on the top and a hexagonal line running across the body of cap;
Said top portion having a central tube-like container to receive the associated supplements;
Said portion with a central tube-like container receiving food grade screen mesh filter to avoid mixing of solid particles of any form of crystal;
said cylindrical portion enclosed within the body of main assembly, with a cork shaped cover having grooves along to provide means for sealing the cylindrical assembly and enclose the supplements balls;
said cylindrical portion cap having central hollow portion to receive the supplement balls and
said bottom portion having a plain center for enhanced stability from which rises the water level and comes in contact with above said interior volume.
